(19) United States
(12) Patent Application Publication
(10) Pub. No.: US 2012/0218457 A1
(43) Pub. Date: Aug. 30, 2012

(54) AUTO-FOCUSING CAMERA DEVICE, STORAGE MEDIUM, AND METHOD FOR AUTOMATICALLY FOCUSING THE CAMERA DEVICE

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/294,198

(22) Filed: Nov. 11, 2011

(30) Foreign Application Priority Data
Feb. 24, 2011 (TW) 100106180

(51) Int. Cl. H04N 5/232

(52) U.S. Cl. 348/345; 348/E05.045

(57) ABSTRACT

In a method for automatically focusing a camera device, the camera device includes a camera lens and a driver device. The method controls the camera lens to capture a scene image in front of a person, and analyze the scene image to detect whether the scene image includes a person image of the person. The method further encloses the person image in the scene image within a rectangular area, and calculates a coordinate value of a center point of the rectangular area and a coordinate value of a midpoint of each edge of the rectangular area. In addition, the method calculates a focusing value of the camera lens according to the coordinate value of the center point and the coordinate value of each of the midpoints, and drives the driver device to adjust the camera lens to a position corresponding to the focusing value.

### BACKGROUND

1. Technical Field

Embodiments of the present disclosure relate to optical devices and methods for adjusting focus of the optical devices, and particularly to an auto-focusing camera device, a storage medium, and a method for automatically focusing the camera device.

2. Description of Related Art

A camera device typically employs a focusing system to automatically focus the camera device. While many cameras are designed with automatic focusing systems, a person must try to set up the camera device within a certain distance of the camera device to allow the focusing system to operate. In order to achieve an optimal image, the person must employ his/her own visual feedback on images captured by the camera device. Automatic focusing systems have been met with some success, but still they do not provide feedback to the person to allow the person to properly focus the camera device.

### BRIEF DESCRIPTION OF THE DRAWINGS

FIG. 1 is a block diagram of one embodiment of an auto-focusing camera device.

FIG. 2 is a flowchart of one embodiment of a method for automatically focusing the camera device of FIG. 1.

FIG. 3 is schematic diagram illustrating one example of the detection of a person in a scene image captured by the camera device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

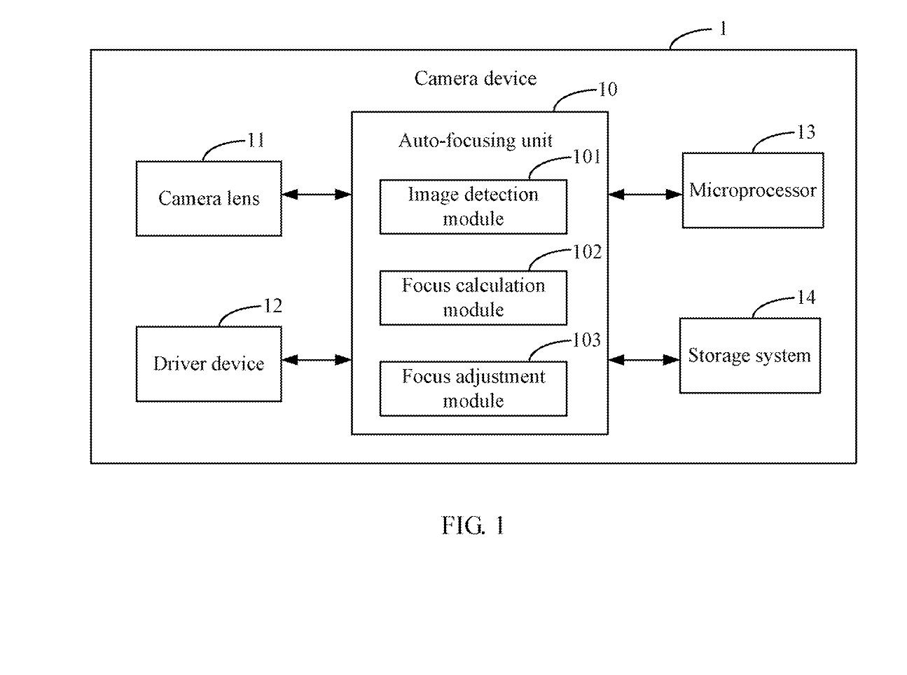

FIG. 1 is a block diagram of one embodiment of an auto-focusing camera device. In the embodiment, the camera device 1 includes an auto-focusing unit 10, a camera lens 11, a driver device 12, a least one microprocessor 13, and a storage system 14. The camera device 1 captures an image of a scene in front of a person (hereinafter “a scene image”), and analyzes the scene image to adjust focus of the camera lens 11 automatically. The camera device 1 may be a digital camera, a video camera, or other image capturing devices. It should be understood that FIG. 1 illustrates only one example of the camera device 1, and may include more or fewer components than illustrated, or those components may be in a different configuration in other embodiments.

The auto-focusing unit 10 can automatically adjust the focus of the camera lens 11 to capture an optimal image of a person. In one embodiment, the optimal image is defined as an image having high brightness and definition. The auto-focusing unit 10 may comprise computerized code in the form of one or more programs that are stored in the storage system 14 and executed by the at least one microprocessor 13. In one embodiment, the storage system 14 may be an internal storage device, such as a random access memory (RAM) for temporary storage of information, and/or a read only memory (ROM) for permanent storage of information. In some embodiments, the storage system 14 may also be an external storage device, such as an external hard disk, a storage card, or a data storage medium.

The camera lens 11 is an optical lens which has adjustable focus within a focusing range, and can obtain an optimal image of the person within the focusing range. In one embodiment, the focusing range may be defined as focusing values from about 0 mm to about 36 mm, and each of the focusing values corresponds to a position or setting of the camera lens 11. The focus value “0 mm” is defined as an initial or starting position of the focusing range, and the focus value “36 mm” is defined as a top or distance limit of the focusing range.

The driver device 12 is configured to control the camera lens 11 to move from the initial position to the top position within the focusing range. In one embodiment, the driver device 3 may be a driving motor that can drive the camera lens 11 to move within the focusing range to change the focus of the camera lens 11 automatically.

In one embodiment, the auto-focusing unit 10 includes an image detection module 101, a focus calculation module 102, and a focus adjustment module 103. The modules 101-103 may comprise computerized code in the form of one or more programs that are stored in the storage system 14. The computerized code includes instructions that are executed by the at least one microprocessor 13 to provide functions for implementing the modules 101-103. In general, the word “module,” as used herein, refers to logic embodied in hardware or firmware, or to a collection of software instructions, written in a program or code-assembly language. In one embodiment, the program language may be Java or C. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

The image detection module 101 is operable to capture a scene image in front of the person using the camera lens 11, and analyze the scene image to detect whether the scene image includes an image of the person (hereinafter “person image”) using a person detection method. In the embodiment, the person detection method may include steps of: pre-storing a large number of characteristics data of people to crate a person sample that includes head, face, eyes and mouth characteristics, comparing image data of the scene image with the characteristics data of the person sample, and determining whether a person is detected in the scene image according to the comparison.

The focus calculation module 102 is operable to enclose the person image within a rectangular area if the scene image includes the person image, and calculate a coordinate value of a center point of the rectangular area and a coordinate value of a midpoint of each edge of the rectangular area. In the embodiment, if a person is detected in the scene image, the focus calculation module 102 determines the ⅔ (approximately 66%) length of the scene image from a head of the person as the length of the rectangular area, and determines a ⅓ (approximately 33%) width of scene image from the head of the person as the width of the rectangular area.

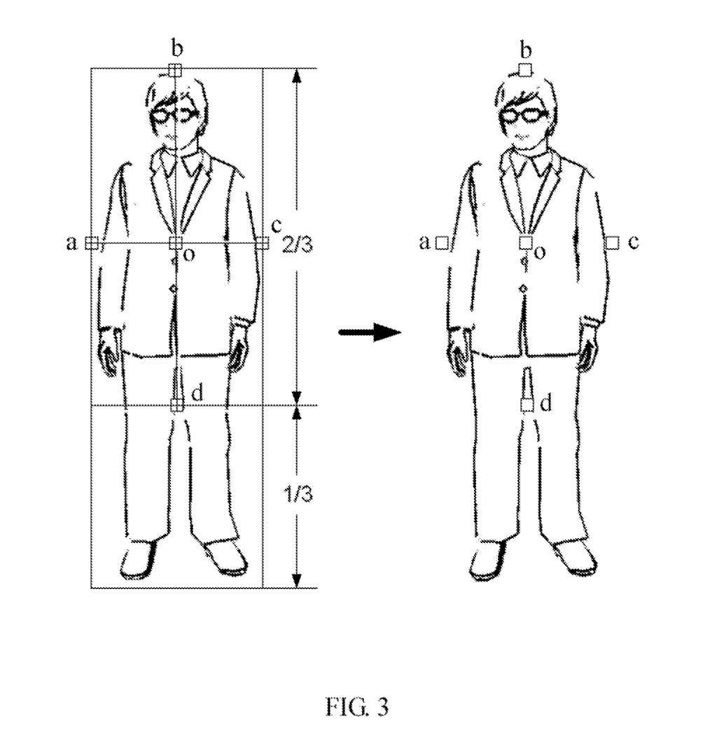

In one example with respect to FIG. 3, the rectangular area has four edges, the center point of the rectangular area is denoted as “O”, and the midpoint of each of the edges is denoted as “a”, “b”, “c” and “d” respectively. In the embodiment, assuming that the length of the scene image is “L” and the width of the scene image is “W”, the focus calculation module 102 creates a coordinate system in the rectangular area based on the center point “O”, and defines the coordinate value of the center point “O” as (0,0). The focus calculation module 102 further calculates the coordinate value of the midpoint “a” as (−⅙*W, 0), the coordinate values of the midpoint “b” as (0, ⅓*L), the coordinate values of the midpoint “c” as (⅙*W, 0), and the coordinate value of the midpoint “d” as (0, −⅓*L).

The focus calculation module 102 is further operable to calculate a focusing value of the camera lens 11 according to the coordinate value of the center point and the coordinate value of each of the midpoints. In one example, the focusing value of the camera lens 11 may be calculated as 10 mm according to the coordinate value of the center point and the coordinate value of each of the midpoints.

The focus adjustment module 103 is operable to drive the driver device 12 to adjust the camera lens 11 to a position corresponding to the calculated focusing value. In one embodiment, the focus adjustment module 103 may generate a driving command according to the focusing value, and control the driver device 12 to drive the camera lens 11 to the required position according to the driving command.

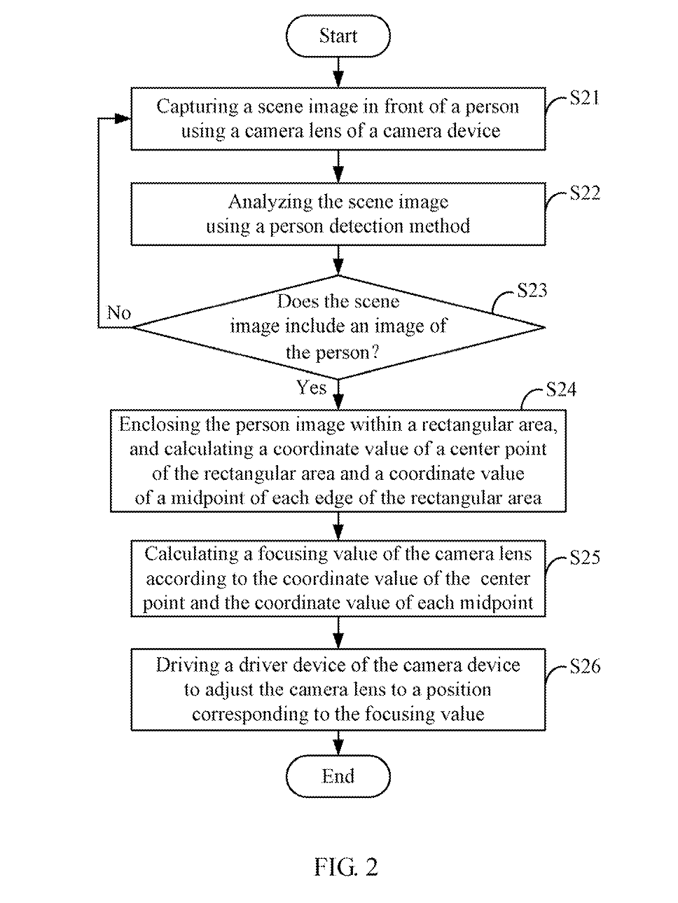

FIG. 2 is a flowchart of one embodiment of a method for automatically focusing the camera device 1 of FIG. 1. The method can automatically adjusts a focus of the camera lens 11, so as to capture an optimal image of a person using the camera device 1. Depending on the embodiment, additional blocks may be added, others removed, and the ordering of the blocks may be changed.

In block S21, the image detection module 101 captures a scene image in front of the person using the camera lens 11. As mentioned above, the scene image is defined as an image of a scene in front of the person.

In block S22, the image detection module 101 analyzes the scene image using a person detection method. In the embodiment, the person detection method may include steps of: pre-storing a large number of characteristics data of people to crate a person sample, and analyzing the scene image comparing image data of the scene image with the characteristics data of the person sample that includes head, face, eyes and mouth characteristics, and determining whether a person is detected in the scene image according to the comparison.

In block S23, the image detection module 101 determines whether the scene image includes an image of the person (hereinafter “person image”) according to the analysis result. If the scene image includes a person image, block S24 is implemented. Otherwise, if the scene image does not include a person image, block S21 is repeated.

In block S24, the focus calculation module 102 encloses the person image within a rectangular area, and calculates a coordinate value of a center point of the rectangular area and a coordinate value of a midpoint of each edge of the rectangular area. In one example with respect to FIG. 3, the rectangular area has four edges, the center point of the rectangular area is denoted as “O”, and the midpoint of each of the edges is denoted as “a”, “b”, “c” and “d” respectively. Assuming that the length of the scene image is “L” and the width of the scene image is “W”, the focus calculation module 102 creates a coordinate system in rectangular area based on the center point “O”, and defines the coordinate value of the center point “O” as (0,0). The focus calculation module 102 further calculates the coordinate value of the midpoint “a” as (−⅙*W, 0), the coordinate value of the midpoint “b” as (0, ⅓*L), the coordinate value of the midpoint “c” as (⅙*W, 0), and the coordinate value of the midpoint “d” as (0, −⅓*L).

In block S25, the focus calculation module 102 calculates a focusing value of the camera lens 11 according to the coordinate value of the center point and the coordinate value of each of the midpoints. In one example, the focusing value of the camera lens 11 may be calculated as 10 mm according to the coordinate value of the center point and the coordinate value of each of the midpoints.

In block S26, the focus adjustment module 103 drives the driver device 12 to adjust the camera lens 11 to a position corresponding to the focusing value. In one embodiment, the focus adjustment module 103 may generate a driving command according to the focusing value, and control the driver device 12 to drive the camera lens 11 to the position according to the driving command. As such, the camera device 1 can capture an optimal image of the person under the focusing value.

All of the processes described above may be embodied in, and fully automated via, functional code modules executed by one or more general purpose processors of the computing devices. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An auto-focusing camera device, comprising:
a camera lens, a driver device, a storage system; and
one or more programs stored in the storage system and executable by at least one microprocessor, the one or more programs comprising:
an image detection module operable to capture a scene image in front of a person using the camera lens, and analyze the scene image to detect whether the scene image includes a person image of the person using a person detection method;
a focus calculation module operable to enclose the person image within a rectangular area, calculate a coordinate value of a center point of the rectangular area and a coordinate value of a midpoint of each edge of the rectangular area, and calculate a focusing value of the camera lens according to the coordinate value of the center point and the coordinate value of each of the midpoints; and
a focus adjustment module operable to drive the driver device to adjust the camera lens to a position corresponding to the focusing value.

2. The camera device according to claim 1, wherein the camera lens is an optical lens which has adjustable focus within a focusing range.

3. The camera device according to claim 2, wherein the driver device is a driving motor that drives the camera lens to move within the focusing range to change the focusing value of the camera lens automatically.

4. The camera device according to claim 1, wherein the person detection method comprises:
pre-storing a large number of characteristics data of people to crate a person sample;
comparing image data of the scene image with the characteristics data of the person sample; and
determining whether the person is detected in the scene image according to the comparison.

5. The camera device according to claim 1, wherein the focus adjustment module generates a driving command according to the focusing value, and controls the driver device to drive the camera lens to the position according to the driving command.

6. The camera device according to claim 1, wherein the coordinate value of each of the midpoints is calculated by steps of:
determining a ⅔ length of the scene image from a head of the person as a length of the rectangular area;
determining a ⅓ width of the scene image from the head of the person as a width of the rectangular area;
creating a coordinate system in the rectangular area according to the center point; and
calculating the coordinate value of each of the midpoints based on the coordinate system according to the length and width of the rectangular area.

7. A method for automatically focusing a camera device, the camera device comprising a camera lens and a driver device, the method comprising:
capturing a scene image in front of a person using the camera lens;
analyzing the scene image to detect whether the scene image includes a person image of the person using a person detection method;
repeating from the capturing step to analyzing step if the scene image does not include the person image, or enclosing the person image within a rectangular area if the scene image includes the person image;
calculating a coordinate value of a center point of the rectangular area and a coordinate value of a midpoint of each edge of the rectangular area;
calculating a focusing value of the camera lens according to the coordinate value of the center point and the coordinate value of each of the midpoints; and
driving the driver device to adjust the camera lens to a position corresponding to the focusing value.

8. The method according to claim 7, wherein the camera lens is an optical lens which has adjustable focus within a focusing range.

9. The method according to claim 8, wherein the driver device is a driving motor that drives the camera lens to move within the focusing range to change the focusing value of the camera lens automatically.

10. The method according to claim 7, wherein the person detection method comprises:
pre-storing a large number of characteristics data of people to create a person sample;
comparing image data of the scene image with the characteristics data of the person sample; and
determining whether the person is detected in the scene image according to the comparison.

11. The method according to claim 7, wherein the driving step comprises:
generating a driving command according to the focusing value; and
controlling the driver device to drive the camera lens to the position according to the driving command.

12. The method according to claim 7, wherein the coordinate value of each of the midpoints is calculated by steps of:
determining a ⅔ length of the scene image from a head of the person as a length of the rectangular area;
determining a ⅓ width of the scene image from the head of the person as a width of the rectangular area;
creating a coordinate system in the rectangular area according to the center point; and
calculating the coordinate value of each of the midpoints based on the coordinate system according to the length and width of the rectangular area.

13. A non-transitory storage medium having stored thereon instructions that, when executed by at least one microprocessor of a camera device, causes the microprocessor to perform a method for automatically focusing the camera device, the camera device comprising a camera lens and a driver device, the method comprising:
capturing a scene image in front of a person using the camera lens;
analyzing the scene image to detect whether the scene image includes a person image of the person using a person detection method;
repeating from the capturing step to analyzing step if the scene image does not include the person image, or enclosing the person image within a rectangular area if the scene image includes the person image;
calculating a coordinate value of a center point of the rectangular area and a coordinate value of a midpoint of each edge of the rectangular area;
calculating a focusing value of the camera lens according to the coordinate value of the center point and the coordinate value of each of the midpoints; and
driving the driver device to adjust the camera lens to a position corresponding to the focusing value.

14. The storage medium according to claim 13, wherein the camera lens is an optical lens which has adjustable focus within a focusing range.

15. The storage medium according to claim 14, wherein the driver device is a driving motor that drives the camera lens to move within the focusing range to change the focusing value of the camera lens automatically.

16. The storage medium according to claim 13, wherein the person detection method comprises:
pre-storing a large number of characteristics data of people to create a person sample;
comparing image data of the scene image with the characteristics data of the person sample; and
determining whether the person is detected in the scene image according to the comparison.

17. The storage medium according to claim 13, wherein the driving step comprises:
generating a driving command according to the focusing value; and
controlling the driver device to drive the camera lens to the position according to the driving command.

18. The storage medium according to claim 13, wherein the coordinate value of each of the midpoints is calculated by steps of:
determining a ⅔ length of the scene image from a head of the person as a length of the rectangular area;
determining a ⅓ width of the scene image from the head of the person as a width of the rectangular area;
creating a coordinate system in the rectangular area according to the center point; and
calculating the coordinate value of each of the midpoints based on the coordinate system according to the length and width of the rectangular area.

19. The storage medium according to claim 13, wherein the storage medium is selected from the group consisting of a hard disk drive, a compact disc, a digital video disc, and a tape drive.
